(19) United States
(12) Patent Application Publication
(10) Pub. No.: US 2005/0047127 A1
(43) Pub. Date: Mar. 3, 2005

(54) Electronic pillar candle

(76) Inventor: Milla Tutman, Aptos, CA (US)

Correspondence Address: MILLA TUTMAN, P.O. BOX 553, CAPITOLA, CA, 95010, US

(21) Appl. No.: 10/647,166

(22) Filed: Aug. 25, 2003

(51) Int. Cl. F21L 4/04

(52) U.S. Cl. 362/205

(57) ABSTRACT

The electronic candle comprising of a plastic cylindrical body with top and bottom, having a flame-shaped tip at the top, the electronic circuitry for providing lighting located inside the candle's body, the sliding “on/off” switch for turning the electronic circuit “on” or “off” and the battery door for the batteries both located on the bottom. The said candle resembles in appearance a partially melted wax pillar candle, and it operates of the user installed standard-size batteries. It uses a programmable micro-controller to generate a variety of glow and flicker patterns closely resembling a real wax candle flame.

### BACKGROUND OF THE INVENTION

The electric candles are used for ceremonial lightings and by businesses such as catering, hospitality, and stage productions. In business use, the electric candles are sometimes preferred to wax or oil-based candles because they do not melt or burn away, produce no smell, and do not create a fire hazard. Most of the electric candles work of the AC power and look more like table or light fixtures. In religious establishments the electric candles are known as the candles for ceremonial lighting purposes such as Christmas or Hanukkah lights. They typically work of AC power, and often resemble candle sticks or light bulbs placed inside the ceremonial fixtures. Such electric candles either do not flicker at all, or flicker in way which does not closely resemble a real flame. Some of the establishments also use electronic battery-operated candles, which resemble candles placed inside a variety of fixtures. These candles have unique shape and size intended for the business applications. They come with built-in rechargeable batteries and a dedicated battery charger base for recharging multiple candles. Some of these candles flicker and some do not. The cost of these candles is justifiable in business use, but it is significantly higher than the cost of wax candles, which the consumers are accustomed to paying for. Also, none of these candles are known to offer scent, which is not typically desired in the establishments, but is one of the significant features desired by many consumers.

In a home use, wax candles remain the candles of choice for many consumers wishing to create a sense of ambience and enjoy various aromas. The wax candles are known in a number of distinct categories, such as votive candles, pillar candles, and candles in the jars. Amongst them, pillar candles are one of the most common and popular. Unlike smaller votive candles, they have a cylindrical shape with a body length significantly bigger than the diameter. They come in different sizes, colors, and scents. They are often placed on a candle holder which adds to a home décor. However, according to the fire marshals across the country, the use of wax candles has become the number one source of residential fires. Also, the wax candles melt away, so the consumers replace them incurring new expenses. Electronic pillar-style candles, if adopted by the consumers, can become a safer and a more economical alternative or a complement to wax pillar candles. For this to happen, the electronic pillar candle may need to resemble closely in appearance and function a real wax pillar candle. It also needs to be affordable to consumers and be close in price range to a real wax pillar candle.

There are only a few known inventions related to battery-operated electronic candles designed to emulate wax candles. They are:

U.S. Pat. No. 6,017,139 to Lederer, G., Jan. 25, 2000, describes a wax candle simulation device and the mechanical design of.

U.S. Pat. No. 6,066,924 to Lederer, G., May 23, 2000, describes a wax candle simulation device and the electrical design of.

UK Patent App. No. GB2,377,327 to Blackbourn L., Jan. 8, 2003, describes electronic candle with a charger base.

None of these inventions mentioned above teach to resemble or emulate a typical consumer wax pillar candle operating of user-installed batteries, but rather a votive-style candle operating of built-in rechargeable batteries requiring a charger base. The described invention is also uniquely different from the above mentioned inventions in appearance, mechanical design, electrical design, features, and visual effects. The main differences between the described invention and these inventions are:

In Appearance and Mechanical Design

the above mentioned inventions describe votive-style candle and not pillar candle, and

the above mentioned inventions do not have a partially-melted wax candle look, and

the above mentioned inventions describe a tip shaped as a wick and not as a flame, and

the above mentioned inventions have a different candle assembly than the described invention.

In Electrical Design, Features, and Effects

the above mentioned inventions are not based on user-installed standard batteries, but on built-in rechargeable batteries drawing power from a dedicated battery charger, and

the above mentioned inventions do not have a battery door and the means for loading or replacing the batteries, and

the above mentioned inventions do not have a sliding “on/off” switch, and

the above mentioned inventions are not based on a programmable micro-controller but on a fixed-stage counter chip, and

the above mentioned inventions have a different flicker pattern which is dependent on the values of analogue components and is not programmable, and

the above mentioned inventions depend on LEDs and their filaments arranged at an angle to provide desired flickering, and

the above mentioned inventions do not describe a scent added to the candle or the holder.

### BRIEF SUMMARY OF THE INVENTION

The main purpose of the described invention is to identify the features and design of the electronic candle which appears and functions closely resembling a real wax pillar candle, and which can be manufactured at a low product cost. Another objective of this invention is to develop a candle with a unique glow-flicker pattern, which can emulate candle glow and flicker in a more natural and relaxing manner than the designs based on non-programmable devices. To achieve these objectives, the described electronic candle is based on the user installed standard batteries and does not require a dedicated battery charger thus allowing for developing a lower cost product than the designs based on built-in rechargeable batteries and a battery charger. Furthermore, the described candle uses a programmable micro-controller thus allowing the glow and flicker patterns to be optimized closer emulating a real flame and not being dependent on the values of analog components as in the other inventions discussed earlier. The described candle has a body shape resembling a partially-melted wax pillar candle. And the tip of the described candle has a flame-like shape unlike other inventions which describe wick-like shaped tip. So when the described candle is turned “on” it appears more like a real wax pillar candle with the flame. The described candle also has features such as a siding on/off switch for added user convenience and battery saving, and a scent for wax candle aroma approximation.

### BRIEF DESCRIPTION OF THE DRAWINGS

FIG. 1 shows the side view of the described candle. It shows the candle body with the tip. Around the tip, it shows a step down around the tip, which is designed to give the candle an appearance resembling a partially-melted wax candle with a deeper melting closer to the tip. The dotted lines show two main internal components such as the user installed batteries and the printed circuit board (PCB).

FIG. 2 shows the top view of the described candle or the top of the candle. This view shows the tip (two inner circles) and a radial top surface step down near the tip.

FIG. 3 shows the bottom view of the described candle or the bottom of the candle. This view shows the location of the sliding “ON/OFF” switch and the battery door.

FIG. 4 shows the diagram for the electronic circuit of the described candle. This view shows a micro-controller chip and associated components for enabling flame-like lighting in the tip.

### DETAILED DESCRIPTION OF THE INVENTION

The described invention describes the electronic candle, which closely resembles in appearance and function a real wax pillar candle, and which can be manufactured and marketed as an affordable product offering consumers the look-and-feel of a real wax pillar candle with an added benefit of safety and the economy of use.

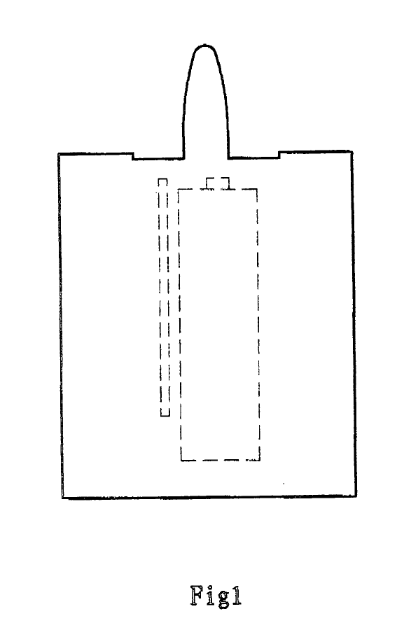

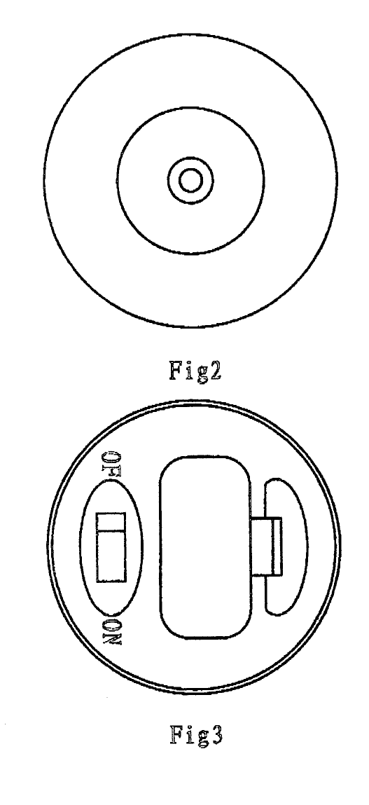

FIG. 1 shows the side view of the described candle, which contains a chamber for the user installed standard batteries and the electronic PCB shown in dotted lines. To facilitate the resemblance of the described candle to a partially-melted wax pillar candle, FIG. 1 and FIG. 2 show a small step down in the top surface around the tip. This step gives the described candle an appearance of a candle, which had melted slightly deeper closer to the flame in the center than towards the outer edge of the candle as common with real wax pillar candles in use. The tip of the candle as shown on FIG. 1 has a flame-like shape. So when the candle is lit, the tip appears more like a real flame as opposed to a wick-shaped tips described in some prior inventions. This gives the candle an additional appearance of a real wax pillar candle in use. Besides designed to resemble a candle's flame, the described tip is shaped to accommodate two LEDs, and to allow it to be made as one plastic body with the candle to minimize the cost of candle manufacture.

FIG. 3 shows the bottom part of the described candle. It shows a sliding “ON/OFF” switch and a battery door. The switch allows the battery to be turned “on” or “off” as desired by the user. Sliding this switch in the “on” position allows the internal electronic circuit to draw power from the user-installed batteries and facilitating lighting in the tip. Sliding the switch in the “off” position electrically disconnects the batteries from the electronic circuit, thus terminating the lighting in the tip and saving on the battery charge. It is expected that the described invention would enable a product capable of providing the amount of continues lighting time comparable to the burn time of a real wax pillar candle of a comparable or bigger size. And using the described “on/off” switch, the lighting time can also be controlled by the user since it is controlled for a real wax candle. The use of the sliding switch is an improvement to other mentioned inventions, which use an external pin inserted into a body of a candle as a method of turning the candle “on” or “off”. Such external pin is expected be present when needed which is not always the case, and it is also not as easy to operate requiring it to be plugged in or pulled out. The other above mentioned inventions rely on such pin method, because they use pins from a charger base as a method of recharging the built-in batteries.

FIG. 3 also shows the battery door for inserting the batteries and locking them in. As mentioned earlier, the described invention operates of user-installed standard-size batteries and it does not require a dedicated battery charger base for recharging the batteries thus allowing the cost of the product based on the described invention to be lower than for the rechargeable inventions. The use of a rechargeable-battery candles as in other inventions is possibly more practical for business use, where such candles can be charged simultaneously and frequently. In a home use, the candle cost is expected to be one of the most determining factors for a consumer.

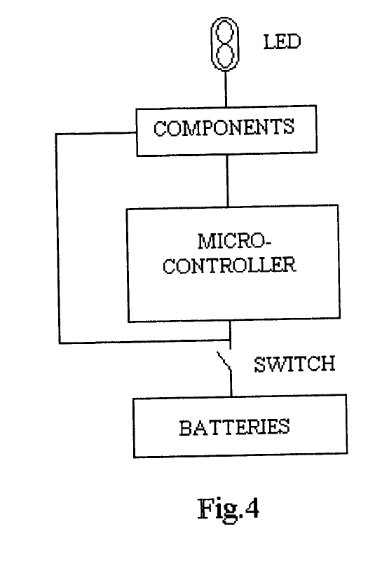

FIG. 4 shows the electronic circuit diagram with the main functional components, which are located inside the candle's body. The main device on this circuit diagram is a basic micro-controller chip. Being a programmable device, this micro-controller allows to create a variety of glow and flicker patterns and to optimize them. This ability allows to facilitate a visual effect that would emulate a candle's flame closer than a design based on a fixed-stage counter chip used in the other mentioned inventions. And unlike these other inventions which depend on the values of analog components and LED positioning to create desired flickering, the described micro-controller based design allows the desired pattern of glow and flickering to be relatively independent of them.

The other part of the circuit consists of several components including two LEDs. When the switch is placed in the “on” or closed position, the battery power is applied to the circuit. Then LEDs receive timing signals from a micro-controller via external components and provide a desired lighting in the tip. The LED brightness is determined by the trade-off between the desired candle brightness and the battery discharge time. As discussed earlier, the micro-controller is programmed to provide a unique timing pattern to LEDs, which is different from all other known patterns. This pattern is fairly random, and is designed to emulate a wax candle's flame so the user perceives it as fairly natural. However, unlike other mentioned inventions, the occurrence of flickers in this pattern is controlled so that they do not appear too intense. This is desirable because the inventions based on a counter chip may produce pseudo-random but continues and often burst-like flickering. Such flickering might resemble a candle facing continues draft, which is not always the case in an indoor environment. Also, frequent burst-like flicker occurrences could stimulate some irritation in the eye and mind of the user. And this might defeat the purpose of using the candle in the first place which is to facilitate the atmosphere of comfort and relaxation, and not just to create random flickering. By using a programmable micro-controller with a unique pattern program, the described invention offers the user a more natural and relaxing visual effect than the inventions using a counter chip. On the other hand, the use of a basic micro-controller as opposed to a microprocessor, allows the described invention to achieve a desired low cost of product implementation.

1. The electronic candle having a plastic body resembling the shape of a partially melted wax pillar candle with a somewhat flame-shaped tip, operating of the user-installed standard batteries, having a sliding on/off switch, and the said candle utilizes a micro-controller to provide a variety of glow or flicker light patterns emulating a wax candle flame.

2. The electronic battery-operated candle with the tip, which uses a micro-controller to facilitate a variety of glow or flicker light patterns emulating a wax candle flame.

3. The electronic battery-operated candle with the tip, having scent emitting substance added to the candle or to the candle holder.
